(19) United States
(12) Patent Application Publication
(10) Pub. No.: US 2009/0188645 A1
(43) Pub. Date: Jul. 30, 2009

(54) TUBE FOULING MONITOR

(75) Inventors: Joseph W. Harpster, Punta Gorda, FL (US); Timothy J. Harpster, Galena, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: INTEC, INC, Westerville, OH (US)

(21) Appl. No.: 12/360,960

(22) Filed: Jan. 28, 2009

Related U.S. Application Data
(60) Provisional application No. 61/062,780, filed on Jan. 28, 2008.

(51) Int. Cl. B60H 1/00

(52) U.S. Cl. 165/11.1

(57) ABSTRACT

A method for measuring the effects of fouling of heat transfer tubes in heat exchangers where a cooling fluid at lower temperature is removing heat from another fluid at higher temperature includes placing a nonrestrictive mass flow rate and temperature measuring tube extension sensor on a tube outlet end; obtaining the tube inlet temperature for deriving the rise in fluid temperature; analytically computing the amount of heat transferred from the hot fluid to the cold fluid; from tube length, inside and outside tube diameter, analytically deriving the tube heat transfer coefficient; and determining tube fouling factor, the value of which is the fraction of the clean tube heat transfer coefficient available for transferring heat, by dividing the heat transfer coefficient by the known heat transfer coefficient of an unfouled tube.

### CROSS-REFERENCE TO RELATED APPLICATIONS

This application claims benefit of provisional application Ser. No. 61/062,780 filed on Jan. 28, 2008, the disclosure of which is expressly incorporated herein by reference.

### STATEMENT REGARDING FEDERALLY SPONSORED RESEARCH

Not applicable.

### BACKGROUND

The present disclosure generally relates to heat exchangers and more particularly, to power plant condensers for determining, by measurement, the extent of internal or external fouling of selected heat exchanger tubes that represent the condition of other nearby tubes in the area. ASME PTC 12.2 methods, related to condensers, suggest individual tube measurements that are expensive and suffer from assumptions of measured steam temperature. The EPRI TR-107397 methods relate to the general field of heat exchangers does address the need to understand flow conditions in individual tubes. Further, the ASME method is costly and the single tube flow equipment is not suitable for long-term use in monitoring condenser or other heat exchanger performance.

Steam turbines are used to provide rotation of most electric power generators in power plants around the world and they require the use of surface condensers to convert the steam to condensate after passing through the turbine. Condensation occurs at subatmospheric pressure of generally between 1.0 to 5.0″ HgA generally by passing cooling water from ponds, rivers, or coastal seas in the amount of about 300,000 gpm through approximately 20,000 tubes of nominally 1″ diameter and 34 feet in length. The source of water can contain trash, precipitates, abrasive materials, biologicals, minerals, and corrosive contaminants that lead to a wide variety of observed deposits that foul or block flow affecting heat transfer and overall performance of the condenser, performance that changes slowly, rapidly, seasonally, or randomly.

The fouling of heat exchanger tubes from chemical or biological contaminants in circulating water or from noncondensable gases on the shell side of condensers is not easily monitored nor quantified throughout the fouling process, particularly as the internal surface of the tube progresses from a clean surface to a thick layer buildup or as tube ends become plugged with debris. When a thick layer develops, its presence is recognized by a significant condenser pressure increase or low heat transfer to or from a second fluid in other heat exchangers. This pressure increase in condensers results from the insulating effect of the fouling that decreases heat transfer coefficient (HTC) of tubes raising the saturation temperature of the steam and its saturation pressure, reducing power generation efficiency. Another contributor to reduce this heat transfer coefficient is the nonuniformity of circulating water flow rate in the tubes.

Under normal conditions of operation, the condenser pressure is known to have fluctuations and drifting up or down based on electrical load being generated, inlet circulating water temperature variations, changes in operating conditions, such as blow-downs, number of venting equipment in use, atmospheric pressure variations, shifts in weather conditions, etc., causing an uncertainty in being able to define a pressure change amounting to less than about 0.3″ HgA and an unknown operating excess expense of up to $400,000 annually. Clearly, a fouling meter for condenser tube fouling that has a sensitivity for identifying fouling caused excess pressure equivalence of less than about 0.1″ HgA is needed to identify when to take corrective actions to reduce tube fouling contributions to condenser pressure. A thermal instrument invented by Joseph Harpster in 1981 (U.S. Pat. No. 4,255,968 or '968 patent) has been known to have sensitivity to coatings, giving rise to the possibility of employing elements from this technology to accurately measure the thickness of the fouling layer as it increases on the inner surface of steam condensing tubes and also in situ, within the instrument's sensor.

The instrument's output flow signal can be a function of the change in heat transfer coefficient of its flow tube containing the flowing fluid. The heat transfer coefficient is a function of the thermal conductance through the flow tube wall, the velocity of the flowing fluid, and the added thickness and type of coating. The instrument also has the ability to measure the tube outlet temperature and mass flow rate of the fluid, which, when combined with an independent measurement of the inlet cooling water temperature, can determine the average fouling over the full length of the tube.

For a condenser tube, the rate of fouling can depend on the tube material, surface finish, flow velocity, and detailed properties of the circulating water, which in general, can be site specific. Typically, the circulating water flow rate is held somewhat constant, except for daily or seasonal variations due primarily to water source elevation changes associated with tides or heavy rains, from internal fouling thickness, or from tube sheet macro fouling. Obviously, heavy fouling will affect flow rate by reducing the flow tube effective internal diameter. The primary reason for maintaining near constant velocity is the flow should be fast enough to reduce particulate deposition and slow enough to minimize particulate abrasion, among others. The typical range employed in power plants is about 5-7 feet per second.

Another source of fouling is on the steam or shell side of the condenser tube. Air may surround certain tubes in the heat exchanger, such as at air bound zones and near or within the air removal section of the condenser. The extent and effect on the heat transfer coefficient is measurable in the same way as internal fouling and identifiable by an analytical comparison with responses of sensors known to be located in the tube bundle outside the air bound zones.

Throttle control is generally not practiced and circulating water pumps run at constant speed. Generally, condensers are supplied with one to three pumps running, and water velocity variations in each tube are mostly dependent on condenser water box debris collection, macro fouling, or tube fouling, and as mentioned, water inlet head pressure from tides and other causes. Further, air can accumulate in the top of the water boxes allowing many upper bundle tubes to run partially full at low velocity or dry. This condition can also promote higher flow rates in the water filled lower tubes that can be monitored.

### BRIEF SUMMARY

Since the instrument described in U.S. Pat. No. 4,255,968 is affected by build up of an insulating layer and its fouling susceptibility can be managed using coatings, the question was posed whether these attributes could be used to construct a fouling meter for an in situ individual condenser tube flow measurements. The suitabilities of the flow-tube version of this device becomes very clear, since there are no internal or intrusive components to obstruct or significantly disturb the flow stream from its conditioning in the relatively straight line flow for the full length of the condenser. Further, for condensers using the “ball cleaning” method to clean tubes or minimize fouling of tubes, the flow meter would to totally compatible, allowing the balls to clean any internal fouling that may appear and allow ball passage through the meter permitting it to directly monitor the effectiveness of cleaning. Since balls have a finite lifetime, another objective for use of the fouling meter is to limit the recirculation time for the ball cleaning process, to that which is only necessary, extending the time between necessary ball replacements.

The instrument sensor consists of a tube, which is plugged into the expanded normal outlet end of selected tube(s) in the outlet water box. Singular or multiple heaters and temperature sensor pairs are located around an outside diameter of the flow tube and sealed in a larger diameter thermally insulated jacket. In one configuration pairs of temperature sensors with one only containing an electrical power heater are used to measure a temperature differential between the two temperature sensor sites which can be used to quantify over time a heat transfer coefficient measurement change that varies with the amount of fouling or change in flow rate. Assuming the circulating water mass flow rate remains constant, the change in ΔT over time becomes a measurement of fouling change. Other pairs may be located at regions containing an antifouling coating to be used as a reference to compare with the fouling sensor pair for quantifying fouling and for water mass flow rate measurement, M_{cw}. Also the reference temperature sensors provide a measure of condenser tube outlet circulating water temperature with the instrument located normally on the outlet end of a condenser tube. This temperature allows determination of the amount of heat absorbed by the water when making use of available inlet circulating water temperature to obtain ΔT_{cw} and from the mass flow rate, using equation 1 (see below). The primary purpose of using multiple sites for locating temperature sensor—temperature sensor/heater pairs around a diameter in the sensor is to obtain an accurate average measurement of fouling signal because of the preferential nature of fouling by precipitation, which accumulates on the bottom of horizontal tubes, minimizing sensor variations from circumferential local fluid velocity differences and possible longitudinal temperature differences in the direction of flow.

Another purpose of the fouling meter is to measure the effects of air in suspected air bound zones of the tube bundle. The existence and description of cause for and the means to remove air bound zones have been identified in U.S. Pat. Nos. 6,526,755 and 7,065,970 by Harpster and continued in pending applications. Air or noncondensable gas on the steam side of condenser tubes have a similar effect on the tube heat transfer coefficient as the fouling on the cooling water side; it interferes with the heat transfer coefficient reducing heat flow. Locating the fouling meter in these air bound regions provides direct thermal impedance measurements of the air bound region, particularly when internal tube fouling is absent. These measurements can be compared to sensors in regions known not to be in air bound regions to determine a measure of fouling on the inside of tubes.

In some applications it may become advantageous to install the disclosed sensor at the normal inlet and of the tube particularly if fouling is sensitive to the temperature rise of the circulating water. Here, the sensor remains relatively clean showing little effect of fouling providing more direct measure of flow rate and inlet circulating water temperature when coupled with an independent measurement of tube outlet temperature which may be obtained with a simple thermocouple sensor, tube fouling is determined in an identical manner as above, using equations (1) through (5).

Also it may become advantageous to install the disclosed sensor on both ends of a heat exchanger tube to measure the effects of fouling differences that may result from unique inlet disturbances vs. outlet conditioned flow stream or from the fouling that may be circulating water temperature dependent, for example, this may happen with biological species that occur in the service water.

The following discussion provides an overall analytical description of the condenser behavior, as may be related to the individual tube measurement behavior. Similar relationships exist for other water to water or water to air heat exchangers. Each individual tube in the condenser will remove an amount heat flow rate, Q, resulting from steam condensation, that may be expressed in three different ways depending on quantities being measured or to be determined:

Q=M_{cw}CₚΔT_{cw}(BTU/Hr) (1)

Q=Mₛh_{fg} (2)

Q=hₐh_{f}UAΔT_{Im}=U_{eff}AΔT_{Im} (3)

where,

U_{eff}=hₐh_{f}U is the effective or measured heat transfer coefficient,

M_{cw} is the mass flow rate of circulating water in a tube,

Cₚ is the heat capacity of cooling water,

ΔT_{cw} is the circulating water temperature rise from inlet to outlet,

Mₛ is the mass flow rate of steam being condensed,

h_{fg} is the heat of condensation of steam,

U is the ideal heat transfer coefficient related to the HEI value,

h is a fouling modifier of U, of less than unity, either from air hₐ on the shell side or water side fouling h_{f}, and may be related to a fouling cleanliness factor,

hₐ, for fouling on the shell side of tubes from air in-leakage or fouling,

h_{f}, for fouling on the water side of tubes or at tube sheets,

A is the outer surface area of each tube,

ΔT_{Im} is the logarithmic mean temperature difference for each tube, and

HEI is the Heat Exchange Institute Incorporated.

The logarithmic mean temperature difference, ΔT_{Im}, is expressed as,

ΔT_{Im}=ΔT_{cw}/In(1+ΔT_{cw}/TTD) (4)

where,

TTD=Tₛ−T_{cw,out,} the terminal temperature difference (5)

Where T_{cw,out} is the outlet circulating water temperature, and

Tₛ is the condenser steam saturation temperature.

These equations 1-5 may be used to describe fouling from measurements made with the fouling monitor. “Fouling”, then, for present purposes includes both the interior of condenser tubes, as well as the outside of such condenser tubes, where heat exchange is diminished. Causes of such fouling can include, inter alia, air, attachment of undesirable materials on the outside, or attachment of contaminants and/or the growth of biological species on the inside, of heat transfer tubes.

### BRIEF DESCRIPTION OF THE DRAWINGS

For a fuller understanding of the nature and advantages of the present apparatus and method, reference should be had to the following detailed description taken in connection with the accompanying drawings, in which:

FIG. 1 is a side view of a typical power plant condenser;

FIG. 2 is perspective partial view of a tube bundle housed within the condenser of FIG. 1;

FIG. 3 is a perspective view of the disclosed tube fouling monitor (TFM);

FIG. 4 is an end view of the TFM of FIG. 3;

FIG. 5 a cross-sectional view along the longitudinal axis of the TFM of FIG. 3; and

FIG. 6 is perspective partial view the tube bundle of FIG. 2 with the TFM installed.

These drawings will be described in detail below.

### DETAILED DESCRIPTION

### A. Purpose

The disclosed Tube Fouling Monitor (TFM) is a unique device used to monitor fluid properties such as flow rate and exit temperature in several selected tubes to calculate tube fouling on the inner and outer wall of the monitored tube as well as monitor in situ the effect of fouling on the clean heat transfer coefficient of the TFM. The ability to monitor this fouling is valuable in maintaining some heat exchanger systems for optimized performance, to identify the cause of high dissolved and deleterious gases in condensate and the need to perform retrofit modifications of the heat exchanger configuration.

For optimized condenser performance, tubes should be as clean as possible and the condenser should operate at below its original design pressure with measured dissolved oxygen below 5 ppb, show relatively uniform outlet circulating water temperature rise from all tubes in the tube bundle and be maintained with air in-leakage below the design capacity of the exhauster at 1.0″ HgA. The TFM is useful for monitoring tubes in the inlet or outlet water box, identifying air or deposit fouling of tubes, allowing action to be taken to achieve optimum condenser performance operations, and providing a redundant temperature measurement of inlet circulating water temperature during reverse flushing, if used.

### B. Description of the Parts

The TFM consists of '968 patent thermal flow meter and other compatible nonrestrictive flow sensors modified with an application specific outer shell, one or multiple flow measurement sites for average fouling measurements and inner tube material and diameter that closely matches the existing flow tube material and inner diameter of the pipe whose fouling is being monitored. The average tube fouling is determined by using the TFM to measure the circulating water mass flow rate and tube outlet water temperature coupled with a separately determined lower tube inlet water temperature to obtain circulating water temperature rise ΔT_{cw}, to obtain a value of Q, as described in equation (1). The combined fouling coefficients hₐ and h_{f} are found by solving equation (3) using the determined Q value. Further, coatings and surface finishes on the inside of the TFM can also be applied to either duplicate, inhibit, or prevent fouling mechanisms at measurement sides in the TFM. Internal tube fouling is inferred from the thermal measurements, which are a direct heat transfer coefficient measurement, and from differences in measured effective heat transfer coefficients in regions with and without antifouling coatings/surfaces. The effect on measurement signal from the antifouling coating region of the TFM is differentiated from a region of fouling in the instrument when used as a stable mass flow meter signal.

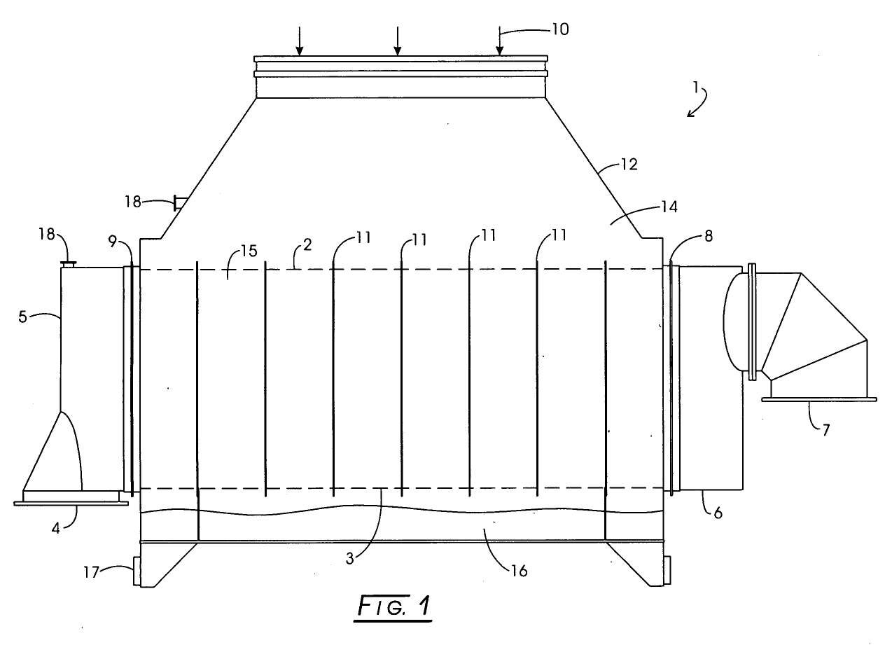

FIG. 1 is a side view of a typical power plant condenser shown generally at 1. Steam, 10, at low pressure and temperature enters at the top passing through a hood, 12, to a tube bundle, 15, of horizontally configured condenser tubes located between an upper limit, 2, and a lower limit, 3. Support plates, 11, having loose fitting holes matching the pattern of tube sheets, 8 and 9, are used to dampen vibrations and support the tube bundle. Each tube in the bundle is seal connected at tube sheets 8 and 9 that provides a seal between the low-pressure side of a condenser shell, 14, from the cooling water at higher pressure passing through the condenser tubes in bundle 15. The inside of each tube in the bundle is in fluid connection with circulating water passing through an inlet pipe connection, 4, entering the condenser at an inlet water box, 5, and exiting a condenser, 7, through an outlet water box, 6. There is a temperature rise in the outlet circulating water at condenser 7 over the inlet temperature at pipe connection 4 due to steam condensation on the outside of each tube within the condenser shell space. The condensate or condensed steam falls to the bottom of the condenser in a region called a hotwell, 16, and removed by a condensate pump (not shown), having a connection to a condensate outlet, 17.

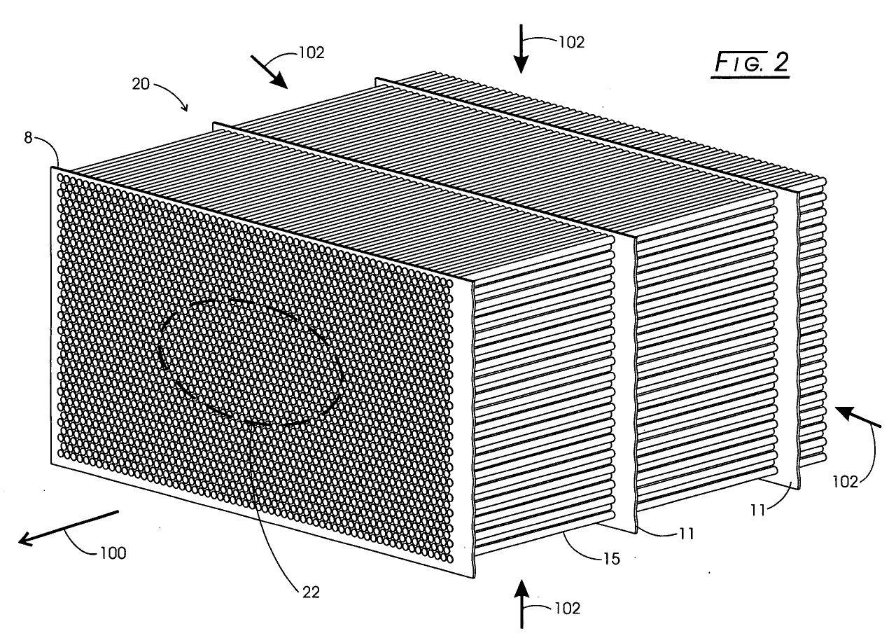

FIG. 2 shows a section of a tube bundle, 20, consisting of an outlet tube sheet, 8, having steam, 102, on the outer side surrounding the array of tubes, 15, having circulating water flowing through them to remove heat from the steam, 102, to form liquid condensate. Also shown are two of several support plates, 11, which maintain bundle tube separation and support for the long tubes that end at the tube sheets as shown at outlet tube sheet 8. It is clear that, if the steam being condensed also contains small amounts of air, the air will be scavenged by the steam to form pockets of air in the tube bundle as indicated by an air pocket region, 22.

Although tube bundle subsections of the type shown in FIG. 2 exist in currently operated condensers, other more subtle bundle configurations will contain these air pockets, or air bound zones, even when configured to have a region of the tube bundle specified as an air removal section. However, because of simplicity, the configuration of FIG. 2 will be used to describe the full utility of the TFMs that get inserted into the outlet circulating water end of selected tubes.

### C. Use

Attachment of a TFM can be achieved using couplers, adhesives such as epoxies, brackets, and/or weld joints. The flow signal is measured and a fouling parameter is calculated by noting a differential measurement between a fouled TFM output and unfouled reference signal or by simply measuring the flow rate and outlet temperature of the cooling water and by use of the inlet circulating water temperatures. The unfouled reference signal can originate from a separate or integrated TFM with a coating or surface finish that inhibits fouling, the original stored signal obtained following insertion at a clean condition, or it can originate from another reference flow or temperature measurement. The TFM electronics operate similarly to '968 patent thermal meter electronics providing flow rate and temperature readings.

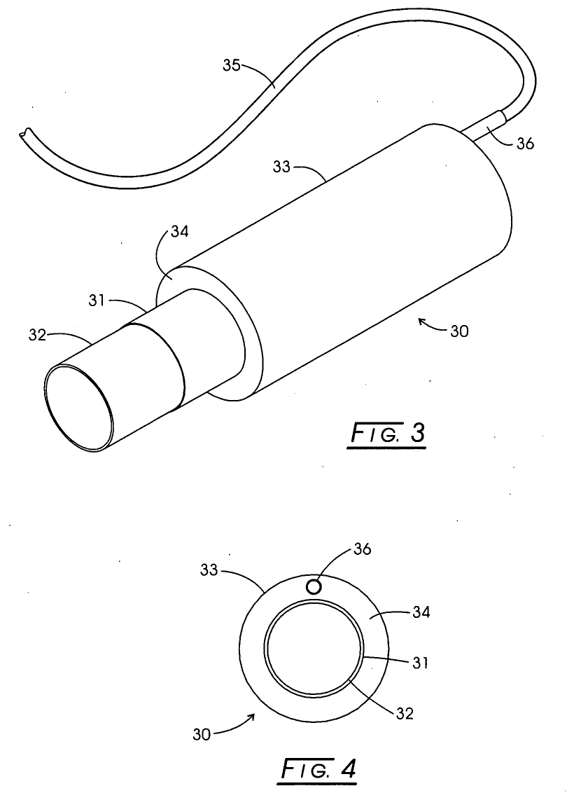

The major features of a TFM, 30, are shown generally in FIG. 3. An inner tube, 31, of the monitor is selected based on the size of tubes used in the condenser. Since tubes in the condenser are typically rolled into slightly oversized holes in the tube sheet, similar sized tubes for the TFM can be used and reduced in outside diameter, or an appropriate adapter, 32, employed, as shown, to slip fit into the rolled outlet end of the condenser tube which is enlarged by the rolling process. Sensor elements, to be shown later, are placed on the outside surface of the inner tube and covered with a jacket, 33, that is seal welded to a ring flange, 34, that has been seal welded to or machined to form inner flow tube 31. An electronic signal cable, 35, is attached to the outlet end of the jacket though a leak tight seal, 36, to provide power and to transmit measurement signals to the electronics, not shown, at other end of cable 35, after the cable is passed through a leak tight seal in the outlet water box.

There are certain features of the TFM that make it unique for the application. It not only takes advantage of the Rheotherm® technology ('968 patent implementation, Intek, Inc., Westerville, Ohio), but the method of measurement can employ other thermal type and non-restrictive flow technologies that exist. For example, the Rheotherm technology uses constant power heaters, whereas other thermal type sensors employ variable power heaters or time of flight thermal pulses. Also, other technologies such as ultrasonic sensors of special design also could apply.

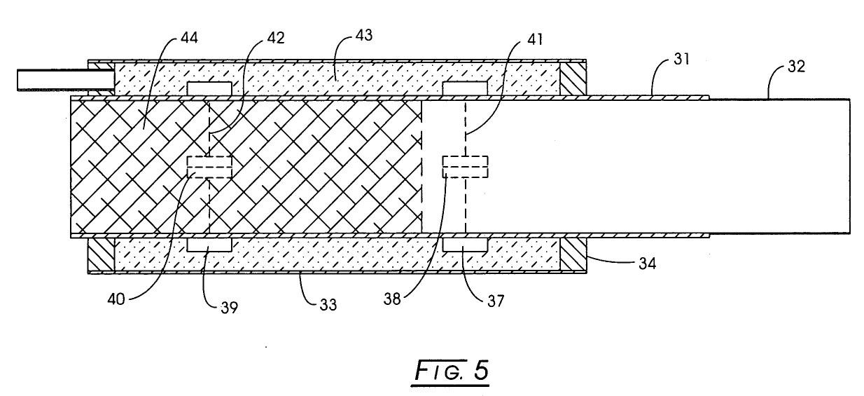

FIG. 4 shows an end view of the central flow tube, 31, having no flow restrictive elements attached to its inner surface, 32. When installed with its inner diameter, 32, closely matching the condenser tube inner diameter the flow pattern is continuous on through the sensor causing effectively no change of water mass flow rate. Inside the sensor shell, for a thermal instrument, as shown in FIG. 5, on the outside of the flow tube are two rings or multiple sites of alternate but equally spaced heater/temperature sensor and temperature sensor pads attached in thermal contact to the tube. Two of each pad are shown, as 37 and 38, for one ring at location 41 and another pair as, 39 and 40, for the other ring at location 42. The space between the center of each copper pad in the ring can be ¼, in one embodiment, of the tube circumference with the heater containing pads on opposite sides of the tube in each ring but this configuration is not absolutely necessary. The space between the outer shell and the inner tube is insulated using appropriate materials such as a foam, 43, to minimize heat transfer between all pads and the outer shell. The outer shell diameter is such as to not interfere with the outlet flow of neighboring flow tubes when a reduced diameter end, 32, is installed in a condenser tube to be measured.

On each ring one heater/temperature sensor and temperature sensor are paired to form two measurement pair sites, which may be individually recorded or averaged to obtain a measured ΔT between the heated and unheated pad sites. Rings are used for measurement pairs to cancel longitudinal thermal gradients that may exist that can affect the flow signal ΔT measurement. As discussed in the '968 patent the ΔT measured signal is approximately proportional to the logarithm of water flow rate and this signal may be used to develop a calibration data set to produce a flow meter. The cause for this relationship is that the heat transfer coefficient changes as a function of water flow rate in the tube. Should fouling occur on the inside of the flow tube the signal would vary, allowing the fouling to be separately measured. To take advantage of this measurement the flow either must be held constant, or be appropriately measured and its change used to modify the determined value for contribution caused by the fouled condition.

With further reference to FIG. 5 the inner tube surface under the region of ring 41 can become fouled in a manner similar to the condenser tube, because the growth and composition of surfaces are closely the same. The surface under ring 42 may, however, be coated or polished to inhibit fouling, as shown at 44. This ring of two heater/temperature sensor and two temperature sensor sites may be used to determine the precise value of the cooling water mass flow rate for use with data from ring 41 measurements to estimate the amount of change in heat transfer coefficient at the location of ring 41 that is due to fouling. In this way the correct flow rate for determining the heat transfer coefficient for ring 41 measurement area would be known, rather than assuming non-varying flow conditions estimate or using another measurement.

Additionally, an independent measurement of the condenser tube heat transfer coefficient can be made for comparison with the above determined fouling of the TFM and for determining, if fouling at both locations are the same. If so, this measurement method provides a redundant measurement of condenser tube fouling effect on heat transfer coefficient. Both rings 41 and 42 can provide an outlet circulating water temperature measurement derived from their unheated reference temperature sensors. This temperature, along with plant measured inlet circulating water temperature, derived from other means, are used to obtain the condenser tube circulating water temperature rise, ΔT_{cw}. By multiplying ΔT_{cw} by the measured tube mass flow rate of circulating water as determined above, and by the circulating water heat capacity, the total amount heat transferred, Q, from steam condensation, can be measured as expressed in equation (1).

From knowledge of the steam temperature, Tₛ, obtained from plant measurements, the value of ΔT_{Im} in equation (4) can be determined; and knowing the outer surface area A, of a tube, along with Q, the value for hₐ·h_{f}·U=U_{eff} can be determined from equation (3). The heat transfer coefficient fouling factors hₐ·h_{f} are then found from the ratio of U_{eff}/U, where U is obtained from the HEI standards. A more direct determination of U may be obtained from the antifouled region, ring 42, at a bundle section free of air, for direct comparison with U_{eff}.

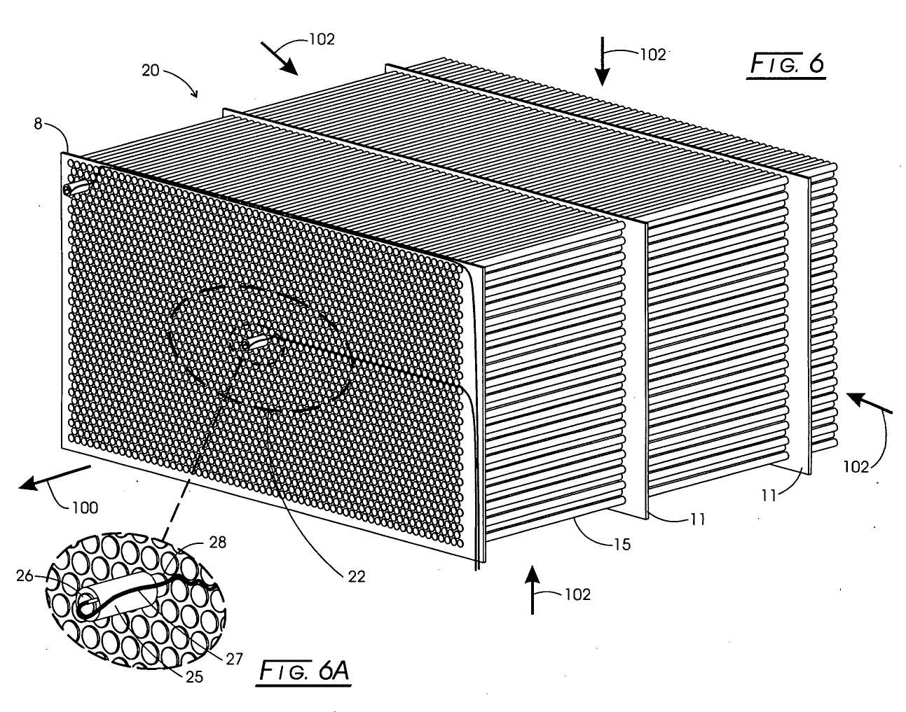

FIG. 6 shows the tube bundle subsection of FIG. 2 with two TFMs installed in tube ends at outlet tube sheet 8. A TFM, 25, is bonded with, for example, an epoxy polymer, suitable for the wet environment between the insertable end and the rolled end of the tube. Brackets or small clamps, either bonded to the tube sheet using the same polymer or other means, also may be employed should added ruggedness be deemed necessary. An electrical cable, 27, is bonded to TMF shell, 25, and between tubes to the tube sheet to an outer exit port through the water box to prevent water velocity induced oscillations of the wire that may destroy this cable. Tube cooling water flow exits the TFM unobstructed through its outlet port, 26.

One sensor is shown located in an air bound zone near the center of the bundle. The other is located near the outside upper portion of the bundle where air binding is most unlikely. Although the latter is free of air caused heat transfer coefficient reduction it may not be assumed that h_{f} is the same at both locations even after long periods of operating time.

### D. TFM Capabilities

The TFM is the only in situ heat transfer measurement for measuring tube fouling. Traditional techniques for individual tube fouling evaluations make assumptions in parameters, such as flow rate, and/or condensing load. The TFM instrument provides valuable data for maintaining and improving heat transfer systems, such as, for example, condensers used in the power generation industry and in general water to water or water to air heat exchangers.

### E. Advantages

The TFM is a unique device for in-situ tube fouling measurements. There are no known devices that exist for this type of in situ, redundant and direct measurement of tube flow, fouling and outlet cooling water temperature. The intrinsic design has no moving parts to fail and can be used for monitoring and measuring flow for long periods of time.

### F. Additional Detail:

The flow sensor is as shown in FIG. 1 and is attached by polymer bonding of an insertable sensor end into the discharge of a selected tube at its circulating water outlet end. The flow meter output has two different types of signal, one related to thermal resistance associated with the metallic wall and fouling layer, and the other is the water temperature, as disclosed in the '968 patent.

For example, four such measurements, using heaters and temperature sensors, can be made as described in the '968 patent with configuration improvements disclosed herein and outlined in FIG. 2 and, then, averaged for accurate measurements. At each measurement site, a coating may be applied to retard fouling. Such coatings can be used to estimate small variations in flow rate when compared to uncoated regions that become fouled. Materials for tube construction can, but are not limited to, the same as used for tubes in the condenser, which would be of particular concern regarding biofouling build up.

Calibration of the instruments is done using clean water as a baseline. Following installation and activation the instrument output can be compared to estimated flow rate achieved at the plant using any other available means. The difference between initial calibration and plant estimates will be recorded and used as a signal normalizing factor. A sufficient number of TFM sensors may be used to determine an average value of individual tube measurement to calibrate gross measurement meters in the circulating water supply lines.

The period between initial readings and the first isolation of the condenser for tube cleaning will be used to calibrate the instrument output as a fouling meter unique to the fouling type at that location. The thickness and particular characteristic of the fouling film will be measured and compared to the recorded output since installation to derive an algorithm defining the fouling thickness. This algorithm, having unique mathematical coefficients, will be used thereafter to estimate the fouling rate and thickness as a function of the meter output signals.

While the apparatus and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the (British) system and all amounts and percentages are by weight, unless otherwise expressly indicated. Also, all citations referred herein are expressly incorporated herein by reference.

We claim:

1. A method for measuring the effects of fouling of heat transfer tubes in heat exchangers where a cooling fluid at lower temperature is removing heat from another fluid at higher temperature, which comprises the steps of:
(a) placing a nonrestrictive mass flow rate and temperature measuring tube extension sensor on a tube outlet end;
(b) obtaining the tube inlet temperature for deriving the rise in fluid temperature;
(c) analytically computing the amount of heat transferred from the hot fluid to the cold fluid;
(d) from tube length, inside and outside tube diameter, analytically deriving the tube heat transfer coefficient; and
(e) determining tube fouling factor, the value of which is the fraction of the clean tube heat transfer coefficient available for transferring heat, by dividing the heat transfer coefficient by the known heat transfer coefficient of an unfouled tube.

2. The method of claim 1, wherein an averaged signal is obtained from multiple location sites in a sensor and the value of said flow rate determined.

3. The method of claim 1, wherein rings of heater/temperature sensor and reference temperature sensor pairs are associated with heat transfer across the sensor wall to the flowing coolant and not caused by longitudinal temperature gradients along the length of the sensor.

4. The method of claim 1 for simulating the fouling factor of a given heat exchange tube system or additionally by employing in the sensor the same material as the heat exchanger tube coating the interior of a sensor exchange tube with a coating of the same expected fouling composition, so that measurements of the fouling factor in the tube could be determined in situ under the assumption that mass flow rate of cooling fluid remains constant.

5. The method of claim 1, wherein coatings or surface finish are applied at selected locations on an inner surface of said tube extension sensor attached to an outlet end of a heat transfer tube to inhibit fouling to improve measurements of the mass flow rate of cooling fluid passing through the sensor.

6. The method of claim 4, wherein each sensor also has a sensor tube extension coated or surface finished on an inner surface location to inhibit fouling, and at another location to promote fouling wherein at least these two measurement sites are used to determine in situ a measured fouling factor by directly measuring an effective mass flow rate ratio at the two measurement sites that have a direct and definable relationship to heat transfer coefficient ratio indicative of a fouling factor.

7. The method of claim 3, wherein the reference temperature sensor signal of the flow sensor is used as an nonrestricted means to measure the condenser tube outlet temperature to obtain the condenser tube temperature rise when combined mathematically with plant measured inlet circulating water temperature and a heated sensor temperature to measure mass flow rate to be combined to obtain a measure of the input heat of condensation on the tube due to condensation.

8. The method of claim 1, wherein which is applied to regions of fouling and regions of no fouling measure heat transfer differences between regions of fouling and in regions of no fouling to analyze the cause for difference in heat transfer coefficient.

9. The method of claim 4, wherein said coatings are evaluated for effectiveness in resisting fouling.

10. The method of claim 1, which is employed following tube cleaning for identifying cause for low heat transfer in tubed heat exchangers that may include one or more of:
(a) regions dominated by air binding,
(b) regions subjected to tube sheet fouling,
(c) regions that may be subjected to high rates of inner tube wall fouling,
(d) regions less prone to fouling of tubes internally,
(e) regions subjected to low cooling water flow rates,
(f) evaluating regions that may be analytically prone to high or low flow rates, or
(g) independently measuring hₐ and h_{f} by appropriate placement of tube fouling meter sensors in a tube bundle.

11. The method of claim 1, which is employed to determined when ball cleaning of the heat exchange tubes is required.

12. The method of claim 1, which is employed with heat exchange tubes in air bound zones or air binding zones.

13. A sensor for monitoring and measuring in situ or by derivation the effects of fouling of heat transfer tubes in heat exchangers that are used to condense steam exhausted from turbines in electric power generating plants, which comprises:
(a) an inner tube;
(b) an adapter for mating said inner tube to an end of said heat transfer tube;
(c) a layer of insulation surrounding said inner tube;
(d) a pair of spaced apart heater/temperature sensors disposed about the outer periphery of said inner tube;
(e) an electronic signal cable in electrical connection with said heater/temperature sensor pairs.

14. The sensor of claim 13, wherein the inside of said inner tube for one of said heater/temperature sensors being treated to be resistant to fouling.

15. The sensor of claim 14, which is used for one or more of:
(a) measuring directly the effective heat transfer coefficient rate of change due to fouling that occurs within the sensor over time resulting from a flow rate signal change under conditions of constant flow rate;
(b) measuring average heat transfer coefficient of a tube by obtaining measured inlet circulating water temperature, the shell side steam temperature and tube geometry, by separate means, and combining these with the described sensors determined circulating water outlet temperature and measured circulating water mass flow rate to calculate the effective heat transfer coefficient, U_{eff}, of the tube; or
(c) determining the fouling modifier of the heat transfer coefficient by measurement between two sites in the sensor one site having similar surface area for fouling as within the tube and the other site having a surface substantially immune to fouling to serve as a reference baseline flow measurement and circulating water mass flow rate measurement.

16. A method of placing the sensor of claim 13 near or at the top row of tubes in a heat exchanger to identify air pocket within the water box through loss or reduced circulating water flow rate or excessive outlet circulating water flow rate.

17. A method of attaching the flow and fouling sensor of claim 13 at the inlet end of a heat exchanger tube and a temperature sensor at the outlet end of the same tube to measure the mass flow rate of circulating water in the tube and the temperature difference across the tube, coupled with independent determination of the steam saturation temperature and tube geometry obtain a determination of the total tube fouling modifier.

18. A method of placing the sensor of claim 13 on each end of a heat exchanger tube to obtain a differential flow signal related to difference in inlet end and outlet end fouling that has a dependence on circulating water temperature such fouling as may be related to specific biological fouling or others but not limited to air binding.
